(19) United States
(12) Patent Application Publication
(10) Pub. No.: US 2019/0097677 A1
(43) Pub. Date: Mar. 28, 2019

(54) MULTI-LAYER RATE SPLITTING FOR WIRELESS COMMUNICATIONS

(71) Applicant: QUALCOMM Incorporated, San Diego, CA (US)

(72) Inventors: Pinar Sen, San Diego, CA (US); Seyong Park, San Diego, CA (US); Haitong Sun, Cupertino, CA (US); Naga Bhushan, San Diego, CA (US); Tingfang Ji, San Diego, CA (US); Tugcan Aktas, San Diego, CA (US)

(21) Appl. No.: 16/143,337

(22) Filed: Sep. 26, 2018

Related U.S. Application Data
(60) Provisional application No. 62/564,853, filed on Sep. 28, 2017.

(51) Int. Cl. H04B 1/7103; H04W 72/04; H04J 13/18; H04B 1/7073

(52) U.S. Cl. CPC H04B 1/7103; H04W 72/0466; H04J 13/004; H04J 13/18; H04B 1/7073; H04W 72/048

(57) ABSTRACT

Methods, systems, and devices for wireless communications are described. A user equipment (UE) may use a lower code rate by splitting a data stream into multiple data sub-streams. The UE may split the data stream to synchronously encode, modulate, and spread the data sub-streams at different layers. Then, the UE may superpose or combine the sub-streams together. The UE may scramble the combined data stream with a UE-specific scrambling code. In some examples, the UE may then apply a cyclic prefix to the combined data stream. The UE may then transmit the combined data stream to a base station. The receiving base station may use layer-wise matched filters and element-wise signal estimators (ESE) to obtain soft information such as log-likelihood ratios. Channel decoders may then determine estimated bits for each layer of each user of the combined data stream.

### CROSS REFERENCES

The present Application for Patent claims the benefit of U.S. Provisional Patent Application No. 62/564,853 by SEN et al., entitled “MULTI-LAYER RATE SPLITTING FOR WIRELESS COMMUNICATIONS,” filed Sep. 28, 2017, assigned to the assignee hereof, and expressly incorporated herein.

### BACKGROUND

The following relates generally to wireless communication, and more specifically to multi-layer rate splitting for wireless communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as a Long Term Evolution (LTE) systems or LTE-Advanced (LTE-A) systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM). A wireless multiple-access communications system may include a number of base stations or network access nodes, each simultaneously supporting communication for multiple communication devices, which may be otherwise known as user equipment (UE).

A base station may be configured to serve a large number of UEs for machine type communications (MTC), for example. The base station and UEs may be configured to communicate using non-orthogonal multiple access (e.g., CDMA) and grant-free transmission schemes. However, traditional code-based communication techniques may be insufficient for high spectrum efficiency requirements (e.g., a high coding rate or a complex modulation and coding scheme (MCS)).

### SUMMARY

The described techniques relate to improved methods, systems, devices, or apparatuses that support multi-layer rate splitting for wireless communications. A UE may use a lower code rate by splitting a data stream into multiple data sub-streams. The UE may split the data stream into a number of different layers and synchronously encode, modulate, and spread the data sub-streams at the different layers. The UE may encode the same number of bits in a code block for each layer. By splitting the data stream, the UE may reduce the average code rate per layer. In some examples, the UE may use a different code rate for each layer, as the number of coded bits per layer is equal. In some examples, layers with a lower code rate may be decoded first and cancelled using a successive cancellation method. The UE may modulate each of the encoded data sub-streams into sets of modulated symbols, then spread each set of modulated symbols using respective spreading codes. In some examples, the number of spread codes may be based on the number of layers or sub-streams. The data sub-streams may be spread by short sequences, where each layer has a corresponding short sequence. In some examples, the short sequences may be orthogonal to each other. In some examples, a data stream may be encoded with a code rate that is based on a number of data sub-streams, and then the encoded data stream may be split into a number of parallel data sub-streams.

After spreading the sub-streams, the UE may superpose or combine the sub-streams together. The UE may scramble the combined data stream with a UE-specific scrambling code. In some examples, the scrambling code may be a pseudorandom scrambling sequence. The UE may apply a phase rotation or a power scaling factor to each sub-stream before combining the sub-streams together. In some examples, the UE may then apply a cyclic prefix to the combined data stream. The UE may then transmit the combined data stream to the base station.

The base station may use layer-wise filters on the received signal to obtain the information bits of the combined data stream. In some cases, the base station may use a matched filter for each layer of each user, filtering based on the UE-specific and layer-specific spread sequences. The filtered signal for each layer may then be run through an element-wise signal estimator (ESE). Residual interference and noise after the matched filters may be approximated as a Gaussian random variable. Soft information, such as log-likelihood ratios, may be iteratively exchanged between channel decoders and the ESEs. The channel decoders may then determine estimated bits for each layer of the combined data stream.

A method of wireless communication is described. The method may include identifying a data stream for transmission to a wireless device, splitting the data stream into multiple data sub-streams, encoding each of the multiple data sub-streams according to a code rate based on a number of the multiple data sub-streams, spreading each of the multiple data sub-streams using respective spreading codes, and transmitting, to the wireless device, a combined data stream that includes each of the spread multiple data sub-streams according to a code division multiplexed scheme.

An apparatus for wireless communication is described. The apparatus may include means for identifying a data stream for transmission to a wireless device, means for splitting the data stream into multiple data sub-streams, means for encoding each of the multiple data sub-streams according to a code rate based on a number of the multiple data sub-streams, means for spreading each of the multiple data sub-streams using respective spreading codes, and means for transmitting, to the wireless device, a combined data stream that includes each of the spread multiple data sub-streams according to a code division multiplexed scheme.

Another apparatus for wireless communication is described. The apparatus may include a processor, memory in electronic communication with the processor, and instructions stored in the memory. The instructions may be operable to cause the processor to identify a data stream for transmission to a wireless device, split the data stream into multiple data sub-streams, encode each of the multiple data sub-streams according to a code rate based on a number of the multiple data sub-streams, spread each of the multiple data sub-streams using respective spreading codes, and transmit, to the wireless device, a combined data stream that includes each of the spread multiple data sub-streams according to a code division multiplexed scheme.

A non-transitory computer readable medium for wireless communication is described. The non-transitory computer-readable medium may include instructions operable to cause a processor to identify a data stream for transmission to a wireless device, split the data stream into multiple data sub-streams, encode each of the multiple data sub-streams according to a code rate based on a number of the multiple data sub-streams, spread each of the multiple data sub-streams using respective spreading codes, and transmit, to the wireless device, a combined data stream that includes each of the spread multiple data sub-streams according to a code division multiplexed scheme.

In some examples of the method, apparatus, and non-transitory computer-readable medium, splitting the data stream comprises: separating a set of information bits of the data stream into multiple subsets of information bits.

In some examples of the method, apparatus, and non-transitory computer-readable medium, a number of encoded bits in respective code blocks for each of the multiple data sub-streams may be the same across each of the multiple data sub-streams.

Some examples of the method, apparatus, and non-transitory computer-readable medium may further include processes, features, means, or instructions for synchronizing the multiple data sub-streams with respect to each other.

In some examples of the method, apparatus, and non-transitory computer-readable medium, the respective average code rates for the multiple data sub-streams may be inversely proportional to the number of the multiple data sub-streams.

In some examples of the method, apparatus, and non-transitory computer-readable medium, the respective average code rates for the multiple data sub-streams may be the same for each of the multiple data sub-streams.

In some examples of the method, apparatus, and non-transitory computer-readable medium, the respective average code rates for the multiple data sub-streams may be proportional to a number of information bits in each of the multiple data sub-streams.

In some examples of the method, apparatus, and non-transitory computer-readable medium, the respective average code rates for the multiple data sub-streams correspond to a ratio of a number of information bits in each of the multiple data sub-streams and a total number of information bits.

In some examples of the method, apparatus, and non-transitory computer-readable medium, a number of the respective spread codes may be equal to the number of the multiple data sub-streams.

In some examples of the method, apparatus, and non-transitory computer-readable medium, the respective spread codes may be orthogonal to each other.

Some examples of the method, apparatus, and non-transitory computer-readable medium may further include processes, features, means, or instructions for modulating each of the encoded multiple data sub-streams onto respective sets of symbols, wherein the modulated encoded multiple data sub-streams may be spread using respective spreading codes.

In some examples of the method, apparatus, and non-transitory computer-readable medium, the respective spread codes for at least two of the multiple data sub-streams may be different.

Some examples of the method, apparatus, and non-transitory computer-readable medium may further include processes, features, means, or instructions for applying a scaling factor to each of the multiple data sub-streams after spreading, wherein the scaling factor comprises one or both of a phase rotation factor or a power scaling factor.

Some examples of the method, apparatus, and non-transitory computer-readable medium may further include processes, features, means, or instructions for combining each of the spread multiple data sub-streams to obtain the combined data stream.

Some examples of the method, apparatus, and non-transitory computer-readable medium may further include processes, features, means, or instructions for applying a scrambling code to the combined data stream prior to transmitting the combined data stream, wherein the scrambling code may be specific to the wireless device.

Some examples of the method, apparatus, and non-transitory computer-readable medium may further include processes, features, means, or instructions for applying a cyclic prefix to the combined data stream prior to transmitting the combined data stream, wherein the cyclic prefix comprises one of a short cyclic prefix or a long cyclic prefix.

In some examples of the method, apparatus, and non-transitory computer-readable medium, the cyclic prefix may be applied after an inverse fast fourier transform of an orthogonal frequency division multiplexing waveform may be performed.

In some examples of the method, apparatus, and non-transitory computer-readable medium, the cyclic prefix may be applied after a discrete fourier transform followed by an inverse fast fourier transform of a discrete fourier transform spread orthogonal frequency division multiplexing waveform may be performed.

A method of wireless communication is described. The method may include identifying a data stream for transmission to a wireless device, encoding the data stream according to a code rate based on a number of multiple data sub-streams, splitting the data stream into multiple data sub-streams based on the number of multiple data sub-streams, spreading each of the multiple data sub-streams using respective spreading codes, and transmitting, to the wireless device, a combined data stream that includes each of the spread multiple data sub-streams according to a code division multiplexed scheme.

An apparatus for wireless communication is described. The apparatus may include means for identifying a data stream for transmission to a wireless device, means for encoding the data stream according to a code rate based on a number of multiple data sub-streams, means for splitting the data stream into multiple data sub-streams based on the number of multiple data sub-streams, means for spreading each of the multiple data sub-streams using respective spreading codes, and means for transmitting, to the wireless device, a combined data stream that includes each of the spread multiple data sub-streams according to a code division multiplexed scheme.

Another apparatus for wireless communication is described. The apparatus may include a processor, memory in electronic communication with the processor, and instructions stored in the memory. The instructions may be operable to cause the processor to identify a data stream for transmission to a wireless device, encode the data stream according to a code rate based on a number of multiple data sub-streams, split the data stream into multiple data sub-streams based on the number of multiple data sub-streams, spread each of the multiple data sub-streams using respective spreading codes, and transmit, to the wireless device, a combined data stream that includes each of the spread multiple data sub-streams according to a code division multiplexed scheme.

A non-transitory computer readable medium for wireless communication is described. The non-transitory computer-readable medium may include instructions operable to cause a processor to identify a data stream for transmission to a wireless device, encode the data stream according to a code rate based on a number of multiple data sub-streams, split the data stream into multiple data sub-streams based on the number of multiple data sub-streams, spread each of the multiple data sub-streams using respective spreading codes, and transmit, to the wireless device, a combined data stream that includes each of the spread multiple data sub-streams according to a code division multiplexed scheme.

A method of wireless communication is described. The method may include receiving a set of code-based signals for multiple wireless devices, identifying multiple layers of a first code-based signal of the set of code-based signals, the first code-based signal corresponding to a first wireless device, computing a set of log-likelihood ratios (LLRs) for each layer of the multiple layers based on one or more sets of LLRs of the multiple layers of the other code-based signals to be used for decoding the first code-based signal, and decoding a set of the multiple layers of the first code-based signal based on one or more sets of LLRs of the multiple layers.

An apparatus for wireless communication is described. The apparatus may include means for receiving a set of code-based signals for multiple wireless devices, means for identifying multiple layers of a first code-based signal of the set of code-based signals, the first code-based signal corresponding to a first wireless device, means for computing a set of LLRs for each layer of the multiple layers based on one or more sets of LLRs of the multiple layers of the other code-based signals to be used for decoding the first code-based signal, and means for decoding a set of the multiple layers of the first code-based signal based on one or more sets of LLRs of the multiple layers.

Another apparatus for wireless communication is described. The apparatus may include a processor, memory in electronic communication with the processor, and instructions stored in the memory. The instructions may be operable to cause the processor to receive a set of code-based signals for multiple wireless devices, identify multiple layers of a first code-based signal of the set of code-based signals, the first code-based signal corresponding to a first wireless device, compute a set of LLRs for each layer of the multiple layers based on one or more sets of LLRs of the multiple layers of the other code-based signals to be used for decoding the first code-based signal, and decode a set of the multiple layers of the first code-based signal based on one or more sets of LLRs of the multiple layers.

A non-transitory computer readable medium for wireless communication is described. The non-transitory computer-readable medium may include instructions operable to cause a processor to receive a set of code-based signals for multiple wireless devices, identify multiple layers of a first code-based signal of the set of code-based signals, the first code-based signal corresponding to a first wireless device, compute a set of LLRs for each layer of the multiple layers based on one or more sets of LLRs of the multiple layers of the other code-based signals to be used for decoding the first code-based signal, and decode a set of the multiple layers of the first code-based signal based on one or more sets of LLRs of the multiple layers.

Some examples of the method, apparatus, and non-transitory computer-readable medium may further include processes, features, means, or instructions for applying respective filters to each layer of the multiple layers of the first code based signal. In some examples, the respective filters may be respective matched filters.

Some examples of the method, apparatus, and non-transitory computer-readable medium may further include processes, features, means, or instructions for applying a signal estimator to each layer of the multiple layers prior to computing the set of LLRs, wherein the signal estimator may be the same for each of the set of code-based signals.

Some examples of the method, apparatus, and non-transitory computer-readable medium may further include processes, features, means, or instructions for computing a second set of LLRs for each layer of the multiple layers based on the decoded set of multiple layers of the first code-based signal and decoding the set of the multiple layers of the first code-based signal based on the second set of LLRs.

In some examples of the method, apparatus, and non-transitory computer-readable medium, the set of the multiple layers comprises each layer for the first wireless device.

### BRIEF DESCRIPTION OF THE DRAWINGS

FIG. 1 illustrates an example of a system for wireless communication that supports multi-layer rate splitting for wireless communications in accordance with aspects of the present disclosure.

FIG. 2 illustrates an example of a wireless communications system that supports multi-layer rate splitting for wireless communications in accordance with aspects of the present disclosure.

FIG. 3 illustrates an example of a multi-layer rate splitting transmitting process that supports multi-layer rate splitting for wireless communications in accordance with aspects of the present disclosure.

FIG. 4 illustrates an example of a multi-layer rate splitting transmitting process that supports multi-layer rate splitting for wireless communications in accordance with aspects of the present disclosure.

FIG. 5 illustrates an example of a multi-layer rate splitting receiving process that supports multi-layer rate splitting for wireless communications in accordance with aspects of the present disclosure.

FIG. 6 illustrates an example of a multi-layer rate splitting receiving process that supports multi-layer rate splitting for wireless communications in accordance with aspects of the present disclosure.

FIG. 7 illustrates an example of a process flow that supports multi-layer rate splitting for wireless communications in accordance with aspects of the present disclosure.

FIGS. 8 through 10 show block diagrams of a device that supports multi-layer rate splitting for wireless communications in accordance with aspects of the present disclosure.

FIG. 11 illustrates a block diagram of a system including a wireless device that supports multi-layer rate splitting for wireless communications in accordance with aspects of the present disclosure.

FIGS. 12 through 14 illustrate methods for multi-layer rate splitting for wireless communications in accordance with aspects of the present disclosure.

### DETAILED DESCRIPTION

A base station may serve a large number of UEs. In some cases, the base station and the UEs may communicate using machine type communications (MTC). In some examples, the base station and the UEs may use non-orthogonal multiple access communications (e.g., code division multiple access (CDMA) communications) and a grant-free transmission scheme. Thus, the base station may serve a large number of UEs for MTC but may only be able to use a limited number of resources. Some CDMA configurations may perform well for low spectrum efficiency but may experience a performance drop for high spectrum efficiency (e.g., a high coding rate or a complex modulation and coding scheme (MCS)).

To improve efficiency, a UE may lower the code rate of a data stream by splitting the data stream into multiple data sub-streams and processing the data sub-streams at different layers. For example, the UE may split a data stream into W data sub-streams and synchronously encode, modulate, and spread the bits of the W sub-streams. In some examples, the UE may encode the same number of bits in a code block for each layer. By splitting the data stream, the UE may reduce the average code rate per layer. For example, the code rate per layer may be reduced to R/W, where R is the code rate for a non-split data stream, and W is the number of layers of the split data stream. In some examples, the UE may use a different code rate for each layer. Each layer may use a different code rate as long as the number of coded bits per layer is equal. In some examples, layers with a lower code rate may be decoded first and cancelled using a successive cancellation method.

The UE may modulate each of the encoded data sub-streams into sets of modulated symbols, then spread each set of modulated symbols using respective spreading codes. In some examples, the number of spread codes may be based on the number of layers or sub-streams. The data sub-streams may be spread by short sequences, where each layer has a corresponding short sequence. In some examples, each short sequence may be orthogonal to the other short sequences. After spreading the sub-streams, the UE may superpose or combine the sub-streams together. The UE may scramble the combined data stream with a scrambling code specific to the UE. For example, a second UE may prepare a combined data stream in a similar manner but use a scrambling code specific to the second UE. In some examples, the scrambling code may be a pseudorandom scrambling sequence. In some examples, the UE may apply a phase rotation or a power scaling factor to each sub-stream before combining the sub-streams together. In some examples, the UE may then apply a cyclic prefix, followed by an inverse fast Fourier transform (IFFT) block, to the combined data stream. In some examples, the UE may apply discrete Fourier transform (DFT)-spreading followed by an IFFT block to the combined data stream, then apply a cyclic prefix. The UE may then transmit the combined data stream to the base station.

The base station may use layer-wise filters on the received signal to obtain the information bits of the combined data stream. For example, the base station may use a matched filter for each layer of each user, filtering based on the UE-specific and layer-specific spread sequences. The filtered signal for each layer may then be run through an element-wise signal estimator (ESE). Residual interference and noise after the filters may be approximated as a Gaussian random variable. Soft information, such as log-likelihood ratios, may be iteratively exchanged between channel decoders and the ESEs. The channel decoders may then determine estimated bits for each layer of the combined data stream.

Aspects of the disclosure are initially described in the context of a wireless communications system. Aspects of the disclosure are further illustrated by and described with reference to apparatus diagrams, system diagrams, and flowcharts that relate to multi-layer rate splitting for wireless communications.

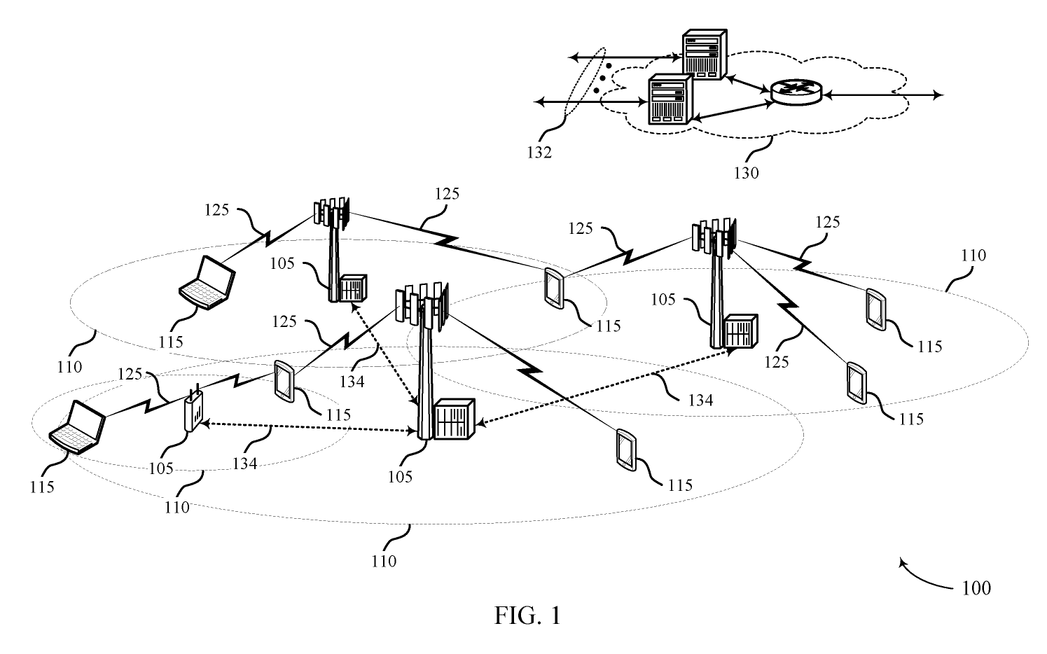

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, or a 5th Generation (5G)/New Radio (NR) network. In some aspects, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions, from a base station 105 to a UE 115. Downlink transmissions may also be called forward link transmissions while uplink transmissions may also be called reverse link transmissions.

The geographic coverage area 110 for a base station 105 may be divided into sectors making up only a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, that may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some aspects, UEs 115 may be designed to support critical functions (e.g., mission critical functions), and a wireless communications system 100 may be configured to provide ultra-reliable communications for these functions.

In some aspects, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some aspects, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1 or other interface). Base stations 105 may communicate with one another over backhaul links 134 (e.g., via an X2 or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), that may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, that itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, that may be an example of an access node controller (ANC). Each access network entity may communicate with UEs 115 through a number of other access network transmission entities, that may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, that may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a CA configuration in conjunction with CCs operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, that may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving devices are equipped with one or more antennas. MIMO communications may employ multipath signal propagation to increase the spectral efficiency by transmitting or receiving multiple signals via different spatial layers, that may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g., synchronization signals, reference signals, beam selection signals, or other control signals) may be transmitted by a base station 105 multiple times in different directions, that may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105. Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, that may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some aspects, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, that may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an E-UTRA absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as OFDM or discrete Fourier transform (DFT)-spread OFDM (DFT-s-OFDM).

The organizational structure of the carriers may be different for different radio access technologies (e.g., LTE, LTE-A, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs that can support simultaneous communications via carriers associated with more than one different carrier bandwidth.

Wireless communications system 100 may support communication with a UE 115 on multiple cells or carriers, a feature that may be referred to as carrier aggregation (CA) or multi-carrier operation. A UE 115 may be configured with multiple downlink CCs and one or more uplink CCs according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other CCs, that may include use of a reduced symbol duration as compared with symbol durations of the other CCs. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications systems such as an NR system may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

Wireless communications system 100 may support techniques for multi-layer rate splitting for wireless communications. A UE 115 may split a data stream into multiple data sub-streams and process each data sub-stream simultaneously at different layers in the device. The UE 115 may be able to use a lower code rate when preparing the data sub-streams, that may improve high spectrum efficiency. A receiving base station 105 may receive signals including symbols prepared by UEs 115 at multiple layers, and the receiving base station 105 may decode and estimate information bits of the received signal accordingly.

In some examples, wireless communications system 100 may support a UE 115 preparing a user data stream for transmission by dividing the user data stream into multiple sub-streams and separately encoding and modulating each sub-stream. The UE 115 may spread each sub-stream such that it is orthogonal to the other sub-streams of the user data stream (e.g., with a short sequence). The UE 115 may then combine the sub-streams into a combined data stream and apply a device-specific sequence to the combined data stream such that a receiving device may distinguish user data streams from one another. As such, the combined data stream may have some similar properties of CDMA transmissions. However, the combined data streams may have improved SNR at a higher spectrum, as the UE 115 may be able to user a lower code rate for each sub-stream.

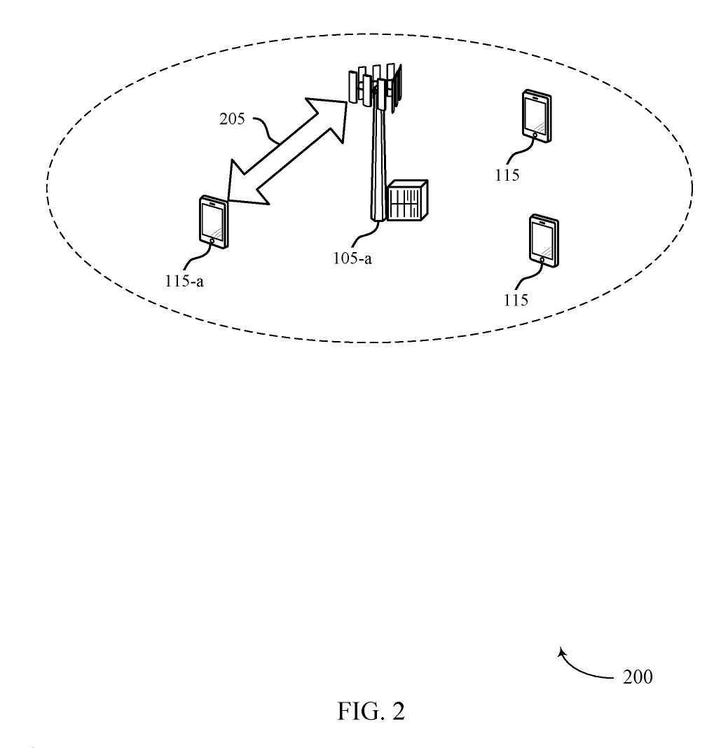

FIG. 2 illustrates an example of a wireless communications system 200 that supports multi-layer rate splitting for wireless communications in accordance with various aspects of the present disclosure. In some examples, wireless communications system 200 may implement aspects of wireless communications system 100. Wireless communications system 200 may include multiple UEs 115, including UE 115-a, which may be examples of a UE 115 as described with reference to FIG. 1. Wireless communications system 200 may also include base station 105-a,which may be an example of base station 105 as described with reference to FIG. 1. UE 115-a and base station 105-a may communicate over a communication link 205.

Base station 105-a may serve multiple UEs 115 for MTC, including UE 115-a. In some examples, base station 105-a and UE 115-a may use non-orthogonal multiple access communications (e.g., CDMA communications) and a grant-free transmission scheme. Thus, base station 105-a may serve a large number of UE 115 for MTC, but may only be able to use a limited number of resources. Some CDMA configurations may perform well for low spectrum efficiency, but may experience a performance drop for high spectrum efficiency (e.g., a high coding rate or a complex modulation and coding scheme (MCS)).

To improve efficiency at higher spectrum, UE 115-a may lower the code rate of a data stream by splitting the data stream into multiple data sub-streams and preparing the data sub-streams at different layers in the device. For example, UE 115-a may split a data stream into W data sub-streams and synchronously encode, modulate, and spread the bits of the W sub-streams. UE 115-a may encode the same number of bits in a code block for each layer.

By splitting the data stream, UE 115-a may reduce the average code rate per layer to R/W, where R is the code rate for a non-split data stream, and W is the number of layers of the split data stream. Thus, UE 115-a may have a lower code rate per layer. For example, if UE 115-a uses a code rate of ½, a two-layer CDMA configuration may use a ¼ code rate (e.g., ½*½) for each layer. Similarly, if UE 115-a uses a code rate of ½, a four-layer CDMA configuration may use a ⅛ code rate (e.g., ½*¼) for each layer.

In some other examples, UE 115-a may use a different code rate for each layer. Each layer may use a different code rate as long as the number of coded bits per layer is equal. For example, a first and second layer may each code X bits and have code rates of 1/16, while a third layer codes 2× bits with a code rate of ⅛, and a fourth layer codes 4× bits with a coding rate of ¼. Thus, despite different code rates, each layer may produce 16× coded bits. In some examples, layers with a lower code rate may be decoded first and cancelled using a successive cancellation method.

UE 115-a may modulate each of the encoded data sub-streams into sets of modulated symbols, then spread each set of modulated symbols using respective spreading codes. In some examples, the number of spread codes may be based on the number of sub-streams (e.g., W sub-streams and W spread codes). The data sub-streams may be spread by short sequences. For example, with W sub-streams, UE 115-a may use short sequences c¹, c², . . . , c^{W}, where each short sequence corresponds to a sub-stream. A short sequence c^{k} may have elements c₁^{k}, c₂^{k}, . . . , c_{X}^{k}, where k=1, 2, . . . W and X is the number of repetitions when spreading. In some examples, each short sequence may be orthogonal to the other short sequences.

After spreading the sub-streams, UE 115-a may superpose or combine the sub-streams together. UE 115-a may scramble the combined data stream with a scrambling code specific to UE 115-a. For example, a second UE 115 may use a scrambling code specific to the second UE 115. In some examples, the scrambling code may be a pseudorandom scrambling sequence. In some examples, UE 115-a may apply a phase rotation or a power scaling factor to each sub-stream before combining the sub-streams together.

In some examples, UE 115-a may apply a cyclic prefix followed by an IFFT block to the combined data stream. The cyclic prefix may include a short cyclic prefix or a long cyclic prefix. In some examples, the cyclic prefix may be added after taking an inverse fast Fourier transform if the waveform is cyclic prefix OFDM. In some other examples, the cyclic prefix may be added after applying a DFT-spread, followed by an inverse fast Fourier transform (IFFT), if the waveform is DFT-s-OFDM. UE 115-a may then transmit the combined data stream (e.g., by the communication link 205).

Base station 105-a may receive the combined data stream and use layer-wise filters on the received signal. For example, base station 105-a may use a matched filter for each layer of each user. The filtered signal may then be run through an ESE for each layer of each user. Residual interference and noise after the matched filters may be approximated as a Gaussian random variable. Soft information, such as log-likelihood ratios, may be iteratively exchanged between channel decoders and the ESEs. The channel decoders may then determine estimated bits for each layer combined data stream.

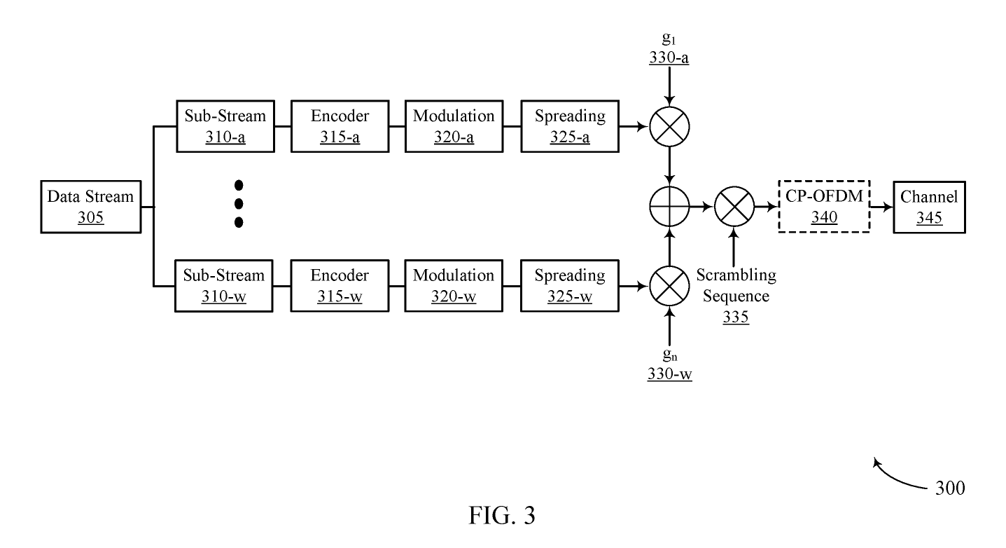

FIG. 3 illustrates an example of a multi-layer rate splitting transmitting process 300 that supports multi-layer rate splitting for wireless communications in accordance with various aspects of the present disclosure. In some examples, multi-layer rate splitting transmitting process 300 may implement aspects of wireless communications system 100. A transmitting device, such as a UE 115, may prepare a data stream to transmit to a receiving device, such as a base station 105.

The UE 115 may process the information bits of the data stream synchronously at different layers by splitting a data stream 305 into data sub-streams 310. For example, the UE 115 may encode, modulate, and spread data sub-stream 310-a at the same time as data sub-stream 310-w. In some examples, splitting the data stream 305 into multiple data sub-streams 310 may lower the code rate at the different layers. Using a lower code rate may improve high spectrum efficiency for some non-orthogonal multiple access wireless systems.

For example, the data stream 305 may be split into W data sub-streams 310, where data sub-stream 310-a is the first of the data sub-streams 310 and data sub-stream 310-w is the Wth of the data sub-streams 310. As an example, the data stream 305 may be split into two data sub-streams 310, where data sub-stream 310-a includes half of the bits and data sub-stream 310-w includes another half of the bits. In some other examples, the data stream 305 may be split into four data sub-streams 310, where each of the four data sub-streams 310 includes a fourth of the bits of the data stream 305.

In some examples, the data stream 305 may be unevenly distributed into the data sub-streams 310. For example, one data sub-stream 310 may have a larger portion of bits of the data stream 305 than another data sub-stream 310. For example, two data sub-streams 310 not shown may each include an eighth of the bits of the data stream 305, data sub-stream 310-a may include half of the bits of the data stream 305, and data sub-stream 310-w may include a fourth of the bits of the data stream 305.

After splitting the data stream 305, the UE 115 may encode each data sub-stream with an encoder 315. The code rate for each layer may be based on the code rate for a single layer (e.g., R, the code rate which may be used without distributing the data stream 305 into multiple layers), the distribution of bits between the layers, and the number of layers. For example, encoder 315-a at the first layer may encode data sub-stream 310-a at a code rate of Rₐ, and encoder 315-w may encode at a rate of R_{w}, where Rₐ is the code rate for the first layer and R_{w} is the code rate for the Wth layer. The code rate for a data sub-stream 310 may be set such that each layer generates the same number of encoded bits, and Rₐ+ . . . +R_{W}=R.

The code rate for a layer may be based on the number of bits included in the layer's data sub-stream 310. For example, if the bits of the data stream 305 is evenly distributed between the data sub-streams 310, Rₐ may be equal to R_{W}. As an example, the code rate for the data stream may be ½, and there may be 4 layers, or data sub-streams 310. Thus, the code rate for each layer may be ⅛ (e.g., R=R/W=½/4=⅛).

In another example, the code rate for the data stream 305 may be ½, sub-stream 310-a may include half of the bits, two sub-streams 310 not shown may include an eight of the total bits, and sub-stream 310-w may include a fourth of the bits, and these sub-streams 310 may use code rates of ¼, 1/16, 1/16, and ⅛ respectively.

After encoding the bits at each layer, the encoded bits may be modulated into symbols. For example, modulation 320-a may modulate the encoded bits of data sub-stream 310-a , and modulation 320-w may modulate the encoded bits of data sub-stream 310-w. The number of symbols generated by the modulation 320 may be based on the number of information bits in the corresponding data sub-stream 310.

The UE 115 may then spread the modulated symbols at each layer. The number of repetitions for a spread may differ between layers. For example, the first layer with data sub-stream 310-a may spread the modulated symbols X times, where the Wth layer with data sub-stream 310-w may spread the modulated symbol X′ times. Thus, spreading 325-a may generate X spread, modulated symbols, and spreading 325-w may generate X′ spread, modulated symbols.

In some examples, the different layers may use different spread sequences. For example, UE 115 may use short sequences c¹, c², . . . , c^{W} for layers 1 through w, corresponding to data sub-stream 310-a through data sub-stream 310-w. Short sequences may include an orthogonal set of vectors. In some examples, the number of different layers may be based on the number of times the spread code is applied (e.g., the spreading factor). For example, a spread code for layer k, c^{k}, may include elements c₁^{k}, c₂^{k}, . . . c_{X}^{k}, where X″=W and is the number of times the spreading sequence is applied, and k ranges from the 1 (e.g., the first layer or data sub-stream 310-a) to W (e.g., the last layer or data sub-stream 310-w). In some aspects, the spread sequences may be Walsh code sequences.

In some examples, the UE 115 may apply a complex scalar 330 to the spread symbols. In some examples, the complex scalar 330 may include a phase rotation, a power scaling, or both a phase rotation and a power scaling. For example, the UE 115 may apply complex scalar 330-a to the spread symbols of the first layer and apply complex scalar 330-w to the spread symbols of the Wth layer. In some examples, layers may use the same complex scalars or different complex scalars.

The UE 115 may then combine spread symbols into a combined data stream. For example, the UE 115 may superpose the data sub-streams 310 into the single, combined data stream. Thus, each layer may use a lower code rate, increasing SNR for the combined data stream.

The UE 115 may then apply a scrambling sequence 335, generating a scrambled signal. In some examples, the scrambling sequence may be a pseudo-random scrambling sequence, or referred to as an outer sequence. In some aspects, the pseudo-random scrambling sequence may be specific to the UE 115. For example, a neighboring UE 115 may perform a similar sub-stream processing technique, but use a different pseudo-random scrambling sequence to distinguish the transmission between devices.

In some examples, the UE 115 may apply a cyclic prefix to the scrambled signal. In some examples, the combined data stream may be transmitted as a cyclic prefix-OFDM (CP-OFDM) waveform. The UE 115 may add the cyclic prefix after taking an IFFT if the waveform is CP-OFDM. In some other examples, the waveform may be DFT-s-OFDM. The UE 115 may add the cyclic prefix after taking the DFT-spreading, followed by IFFT, if the waveform is DFT-s-OFDM. The UE 115 may then transmit the combined data stream.

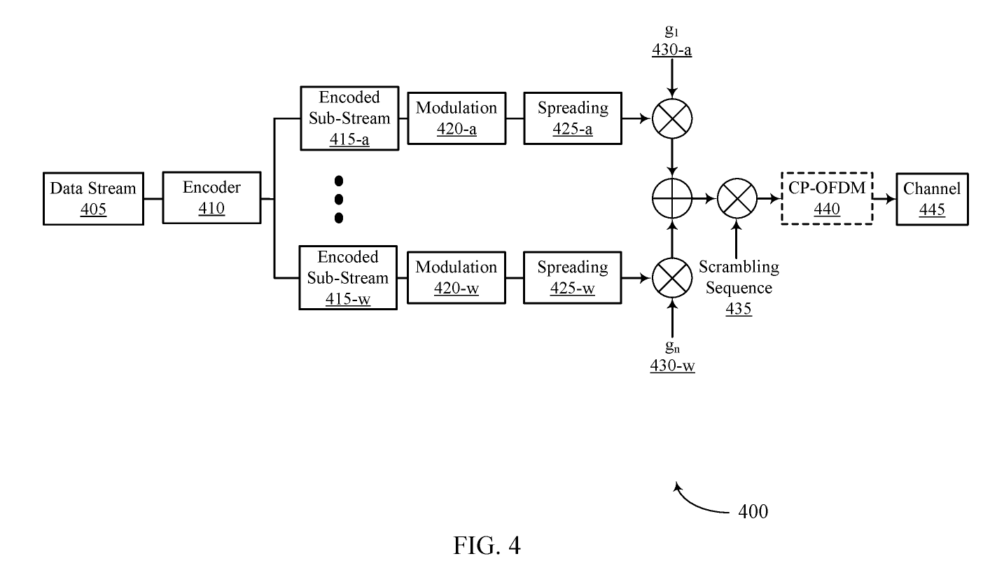

FIG. 4 illustrates an example of a multi-layer rate splitting transmitting process 400 that supports multi-layer rate splitting for wireless communications in accordance with various aspects of the present disclosure. In some examples, multi-layer rate splitting transmitting process 400 may implement aspects of wireless communications system 100. A UE 115 may prepare a data stream 405 for uplink transmission to a base station 105 by splitting the data stream 405 into multiple sub-streams and preparing the sub-streams at multiple layers in the UE 115.

In some examples, a UE 115 may encode the data stream 405 with an encoder 410 before splitting into multiple encoded sub-streams 415. The UE 115 may encode the data stream 405 with a code rate based on the number of encoded sub-streams 415 (e.g., a code rate of R/W as described with reference to FIG. 3). In some examples, a code (e.g., a low-density parity check (LDPC) code) with a longer block length may have better performance. When the UE 115 splits after encoding, the code block may have a longer block length.

After splitting the encoded bits, the UE 115 may prepare the split data-streams as described with reference FIG. 3. For example, the UE 115 may modulate first encoded sub-stream 415 with the modulator 420-a and modulate Wth encoded sub-stream 415-w with modulator 420-w. The UE 115 may apply spreading 425-a and spreading 425-w to the first and Wth sub-streams, respectively. In some examples, the UE 115 may apply complex scalars 430-a and 430-w to the first and Wth encoded sub-streams 415 respectively, then combine the sub-streams and scramble the combined data stream with a scrambling sequence 435. In some examples, the UE 115 may apply a cyclic prefix to the combined data stream as described with reference to FIG. 3. Then, the UE 115 may transmit the combined data stream on an uplink channel 445.

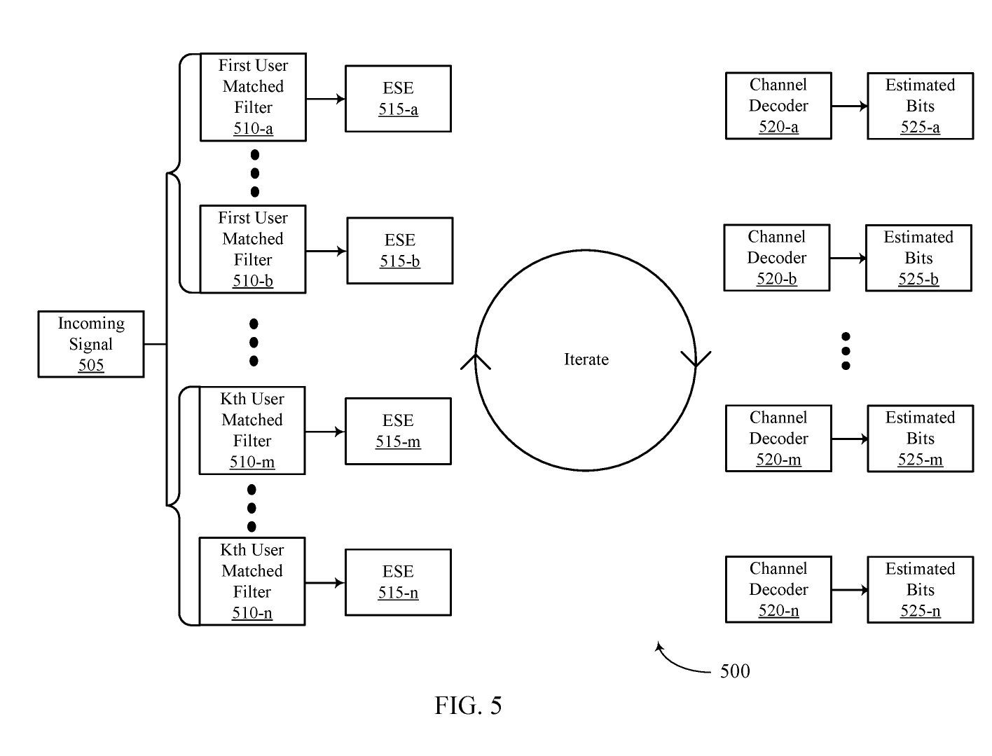

FIG. 5 illustrates an example of a multi-layer rate splitting receiving process 500 that supports multi-layer rate splitting for wireless communications in accordance with various aspects of the present disclosure. In some examples, multi-layer rate splitting receiving process 500 may implement aspects of wireless communications system 100. A UE 115 may transmit a combined data stream to a base station 105, prepared (e.g., modulated, encoded, etc.) as described herein. In some examples, the combined data stream may be encoded after being split into multiple data sub-streams.

A receiving device, such as a base station 105, may receive an incoming signal 505, which may include signals from multiple transmitting UEs 115. For example, the incoming signal 505 may include multiple combined data streams, prepared as described in FIGS. 2-3. As illustrated, the incoming signal 505 may include combined data streams for K different UEs 115. In some other examples, the receiving device may estimate bits as described for a single transmitting UE 115.

The receiving device may identify the total number of layers, L, as the total number of transmitting UEs 115 multiplied by the number of layers used at each transmitting UE 115. In some examples, a transmitting UE 115 may transmit one modulated symbol per layer. Thus, the total symbols transmitted may be represented as the transmit vector s=[s₁, s₂, . . . , S_{L}]. For an additive white Gaussian noise (AWGN) channel, the received vector may be represented as y=Hs+n. H may be an X×L matrix, with columns of H=[h₁, h₂, . . . , h_{L}]. In some examples, X may be the spreading factor, which may consider the short (e.g., inner) and long (e.g., outer) spread sequences. In some examples, n may be complex white Gaussian noise.

The receiving device may use a matched filter 510 to layer-wise filter the incoming signal 505 per transmitting UE 115. For example, each combined data stream of the incoming signal 505 may have been encoded with an outer sequence unique to the transmitting UE 115. Thus, the receiving device may identify data streams for each transmitting UE 115 based on the device-specific, outer sequence applied to each user data stream and filter the incoming signal 505 into the data streams for each transmitting UE 115. For example, first user matched filter 510-a and first user matched filter 510-b may filter the incoming signal for transmissions from a first UE 115, while Kth user matched filter 510-m and Kth user matched filter 510-n may filter the incoming signal 505 for transmission from a Kth UE 115.

The matched filters 510 may also filter a combined data stream of one user into the multiple layers, where the layers are as described in FIGS. 2-3. For example, first user matched filter 510-a may be used to filter the combined data stream of the first UE 115 and detect the symbols prepared at the first layer of the first UE 115. Similarly, first user matched filter 510-b may be used to filter the combined data stream of the first UE 115 to detect the symbols prepared at the Wth layer of the first UE 115, where the first UE 115 prepared its combined data stream using W layers.

Similarly, Kth user matched filter 510-m may be used to detect the first layer of the Kth UE 115, and Kth user matched filter 510-n may be used to detect the W′th layer of the Kth UE 115. In some examples, W and W′ may be the same number of layers, or they may be a different number of layers.

For example, a matched filter output for a given layer i may be equal to

$${y}_{i} = {\vert {h}_{i} \vert}^{2} {s}_{i} + {\sum }_{j \neq i} {h}_{i}^{H} {h}_{j} {s}_{j} + {h}_{i}^{H} n \qquad ( 1 )$$

where Σ_{j≠i}hᵢ^{H}hⱼsⱼ+hᵢ^{H}n is interference and noise from other transmitting UEs and other layers. In some examples, the interference and noise may have a Gaussian distribution. In some other examples, the receiving device may additionally, or alternatively, use a different type of filter to filter the incoming signal 505 into per-UE sub-streams.

The output from each matched filter may be passed to an ESE 515. The ESE 515 may element-wise estimate which signals are transmitted per layer. In some aspects, residual interference and noise after the matched filter may be approximated as a Gaussian random variable.

An ESE 515 may compute a log-likelihood ratio (LLR) for each symbol, each stream, and each UE. For example, ESE 515-a may compute an LLR for a symbol transmitted on a first layer of the first UE 115, and ESE 515-b may compute an LLR for a symbol transmitted on a Wth layer of the first UE 115. Similarly, ESE 515-m may compute an LLR for a symbol transmitted on a first layer of the Kth UE 115, and ESE 515-n may compute an LLR for a symbol transmitted on the W′th layer of the Kth UE 115.

The receiving device may also use a channel decoder to obtain the original bits as transmitted by the transmitting UEs 115. The receiving device may iterate between using an ESE 515 and a channel decoder 520 to refine the bit estimation. Soft information such as LLRs may be exchanged between the ESEs 515 and the channel decoders 520 until the estimated bits 525 represent the bits transmitted by each UE 115. For example, the output of the channel decoders 520 may be used by the ESEs 515 to obtain another set of LLRs. The exchange between ESEs 515 and the channel decoders 520 may be repeated until the estimated bits represent the bits as transmitted by the transmitting UEs 115.

For example, the receiving device may iterate between ESE 515-a and channel decoder 520-a to obtain estimated bits 525-a, which may represent the bits of the symbol prepared on the first layer of the first UE 115. Further, the receiving device may iterate between ESE 515-b and channel decoder 520-b to obtain estimated bits 525-b, which may represent the bits of the symbol prepared on the first layer of the first UE 115. The receiving device may perform similar iterations to obtain estimated bits 525-m and estimated bits 525-n, which may be bits of the symbols transmitted by the Kth UE 115 and prepared, respectively, on the first layer and W′th layer of the Kth UE 115.

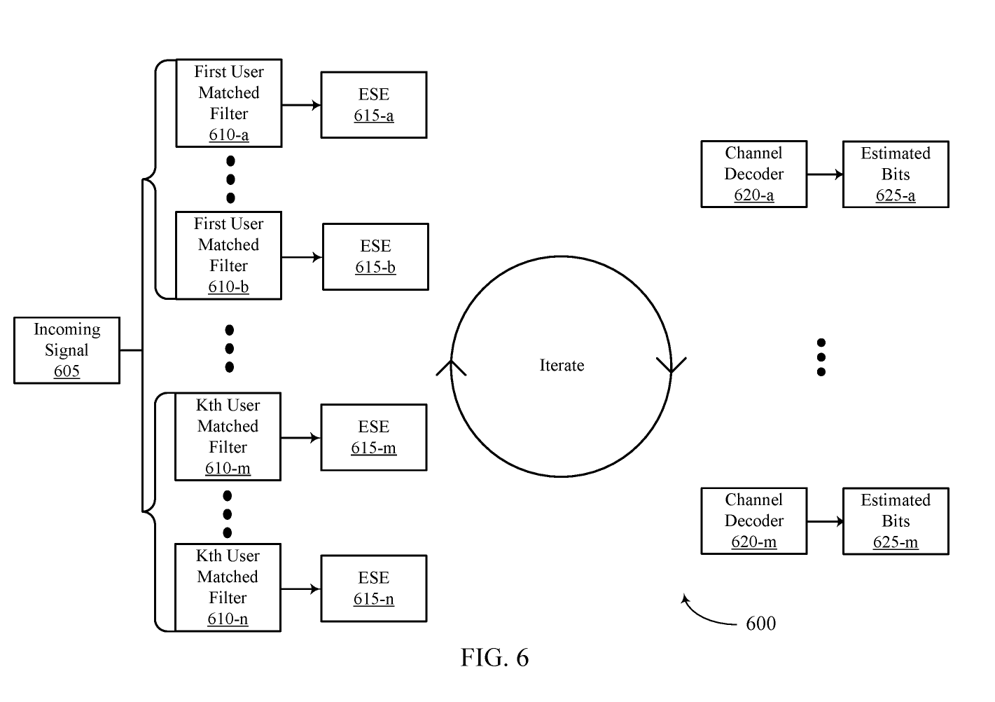

FIG. 6 illustrates an example of a multi-layer rate splitting receiving process 600 that supports multi-layer rate splitting for wireless communications in accordance with various aspects of the present disclosure. In some examples, multi-layer rate splitting receiving process 600 may implement aspects of wireless communications system 100. A base station 105 may receive a combined data stream from a UE 115. The combined data stream, as prepared by the UE 115, may have been encoded prior to splitting into multiple data sub-streams.

A receiving device, such as a base station 105, may receive an incoming signal 605, which may include signals from multiple transmitting UEs 115. For example, the incoming signal 605 may include multiple combined data streams, prepared as described in FIGS. 2-3. As illustrated, the incoming signal 605 may include combined data streams for K different UEs 115. In some other examples, the receiving device may estimate bits as described for a single transmitting UE 115.

In some examples, the transmitting UEs 115 may prepare the combined data stream as described with reference to FIG. 4. That is, the UEs 115 may encode the data stream before splitting the data stream. The base station 105 may receive the incoming signal 605 and use matched filters 610 (e.g., first user matched filters 610-a and 610-b and Kth user matched filters 610-m and 610-n) and ESEs 615 (e.g., ESE 615-a, 615-b, 615-m, and 615-n) as described with reference to FIG. 5 to receive soft information (e.g., LLRs) corresponding to the combined data streams transmitted by the UEs 115 received in the incoming signal 605.

In contrast to FIG. 5, the number of channel decoding operations at the base station 105 may be based on the number of users, as opposed to the number of total layers among all users. LLRs for encoded bits for a user may be concatenated first (e.g., going from being handled in parallel to handled in series) then given to a channel decoder 620. For example, channel decoder 620-a may decode a concatenated LLR block to obtain estimated information bits for the first user. Similarly, channel decoder 620-m may decode a concatenated LLR block to obtain estimated information bits for the Kth user.

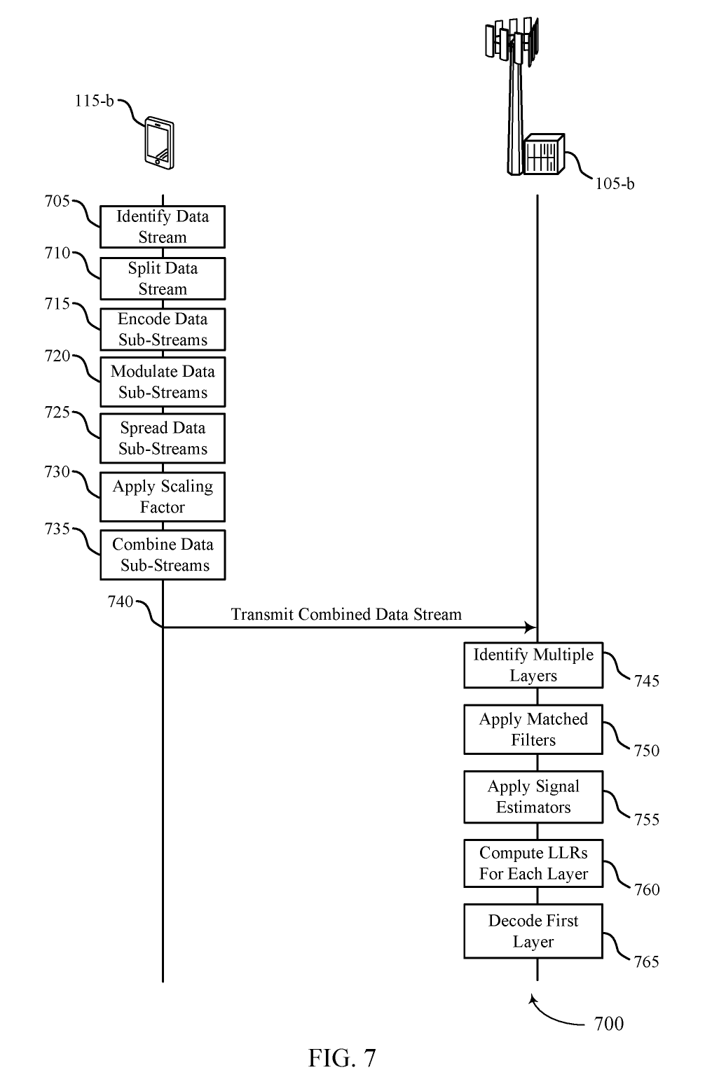

FIG. 7 illustrates an example of a process flow 700 that supports multi-layer rate splitting for wireless communications in accordance with various aspects of the present disclosure. In some examples, process flow 700 may implement aspects of wireless communications system 100. Process flow 700 may include UE 115-b and base station 105-b, which may be respective examples of a UE 115 and a base station 105 as described with reference to FIGS. 1 and 2. UE 115-b may prepare a data stream to transmit to base station 105-b.

At 705, UE 115-b may identify a data stream for transmission. In some examples, the data stream may include a number of information bits to be transmitted. At 710, UE 115-b may split the data stream into multiple data sub-streams. UE 115-b may separate a set of information bits of the data stream into multiple subsets of information bits. In some examples, each of the multiple subsets of information bits may include the same, or approximately the same, number of information bits. In some other examples, each of the subsets of information bits may include a different number of information bits.

At 715, UE 115-b may encode each of the multiple data sub-streams. UE 115-b may encode each of the multiple data sub-streams based on the number of multiple data sub-streams. In some examples, UE 115-b may encode each of the multiple data sub-streams based on how the bits of the data stream are distributed among each of the data sub-streams. In some examples, the average code rate per layer may be inversely proportional to the number of the multiple data sub-streams.

At 720, UE 115-b may modulate each of the encoded multiple data sub-streams onto respective sets of symbols. Then, at 725, UE 115-b may spread each of the multiple data sub-streams using respective spreading codes. In some examples, the modulated encoded multiple data sub-streams may be spread using respective spreading codes. In some examples, UE 115-b may make the data sub-streams orthogonal to each other by applying the spreading codes to the layers.

At 730, UE 115-b may apply a scaling factor to each of the multiple data sub-streams after spreading them, where the scaling factor may include one of a phase rotation factor or a power scaling factor, or both a phase rotation factor and a power scaling factor. Then, at 735, UE 115-b may combine the data streams together.

In some examples, UE 115-b may apply a scrambling code to the combined data stream prior to transmitting the combined data stream. In some examples, the scrambling code may be specific to UE 115-b. In some examples, base station 105-b may be able to identify each user data stream based on the device-specific scrambling code, or outer sequence. In some examples, UE 115-b may apply a cyclic prefix to the combined data stream prior to transmitting the combined data stream. The cyclic prefix may include a short cyclic prefix or a long cyclic prefix. UE 115-b may then transmit the combined data stream to base station 105-b at 740.

Base station 105-b may receive a set of code-based signals from multiple wireless devices, including the combined data stream transmitted by UE 115-b. At 745, base station 105-b may identify multiple layers of a first code-based signal of the set of code-based signals, the first code-based signal corresponding to UE 115-b.

At 750, base station 105-b may apply respective matched filters to each layer of the multiple layers of the first code-based signal. In some examples, base station 105-b may apply a signal estimator to each layer of the multiple layers at 755, where the signal estimator is the same for each of the set of code-based signals. Then, at 760 base station 105-b may compute a set of LLRs for each layer of the multiple layers based at least in part on one or more sets of LLRs of the multiple layers of the other code-based signals to be used for decoding the first code-based signal. Then, at 765, base station 105-b may decode a first layer of the first code-based signal based on one or more sets of LLRs of the multiple layers.

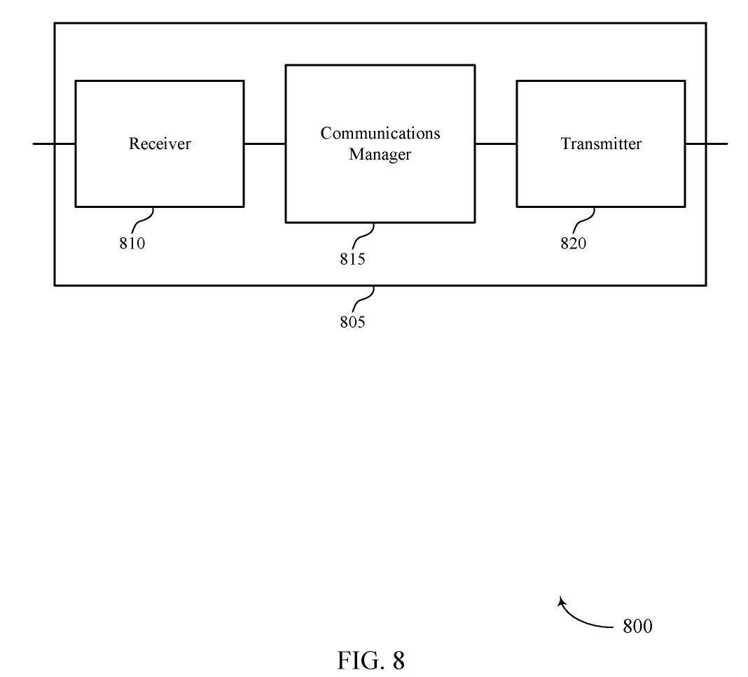

FIG. 8 shows a block diagram 800 of a wireless device 805 that supports multi-layer rate splitting for wireless communications in accordance with aspects of the present disclosure. Wireless device 805 may be an example of aspects of a base station 105 or UE 115 as described herein. Wireless device 805 may include receiver 810, communications manager 815, and transmitter 820. Wireless device 805 may also include a processor. Each of these components may be in communication with one another (e.g., via one or more buses).

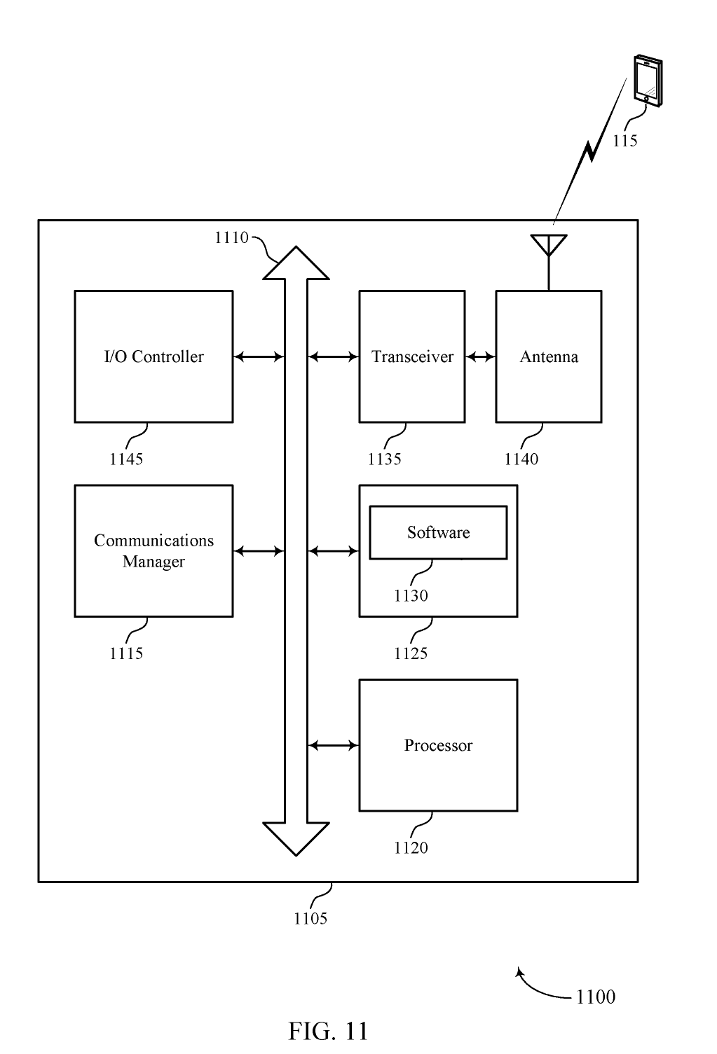

Receiver 810 may receive information such as packets, user data, or control information associated with various information channels (e.g., control channels, data channels, and information related to multi-layer rate splitting for wireless communications, etc.). Information may be passed on to other components of the device. The receiver 810 may be an example of aspects of the transceiver 1135 described with reference to FIG. 11. The receiver 810 may utilize a single antenna or a set of antennas.

Communications manager 815 may be an example of aspects of the communications manager 1115 described with reference to FIG. 11. Communications manager 815 and/or at least some of its various sub-components may be implemented in hardware, software executed by a processor, firmware, or any combination thereof. If implemented in software executed by a processor, the functions of the communications manager 815 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure.

The communications manager 815 and/or at least some of its various sub-components may be physically located at various positions, including being distributed such that portions of functions are implemented at different physical locations by one or more physical devices. In some examples, communications manager 815 and/or at least some of its various sub-components may be a separate and distinct component in accordance with various aspects of the present disclosure. In other examples, communications manager 815 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Communications manager 815 may identify a data stream for transmission to a wireless device, split the data stream into multiple data sub-streams, encode each of the multiple data sub-streams according to a code rate based on a number of the multiple data sub-streams, spread each of the multiple data sub-streams using respective spreading codes, and transmit, to the wireless device, a combined data stream that includes each of the spread multiple data sub-streams according to a code division multiplexed scheme. The communications manager 815 may also identify a data stream for transmission to a wireless device, encode the data stream according to a code rate based on a number of multiple data sub-streams, split the encoded data stream into multiple encoded data sub-streams based on the number of multiple data sub-streams, spread each of the multiple encoded data sub-streams using respective spreading codes, and transmit, to the wireless device, a combined data stream that includes each of the encoded spread multiple data sub-streams according to a code division multiplexed scheme. The communications manager 815 may also receive a set of code-based signals for multiple wireless devices, identify multiple layers of a first code-based signal of the set of code-based signals, the first code-based signal corresponding to a first wireless device, compute a set of LLRs for each layer of the multiple layers based at least in part on one or more sets of LLRs of the multiple layers of the other code-based signals to be used for decoding the first code-based signal, and decode a set of the multiple layers of the first code-based signal based on one or more sets of LLRs of the multiple layers. In some cases, the communications manager 815 may apply respective filters to each layer of the multiple layers of the first code-based signal. In some cases, the respective filters may be respective matched filters.

Transmitter 820 may transmit signals generated by other components of the device. In some examples, the transmitter 820 may be collocated with a receiver 810 in a transceiver module. For example, the transmitter 820 may be an example of aspects of the transceiver 1135 described with reference to FIG. 11. The transmitter 820 may utilize a single antenna or a set of antennas.

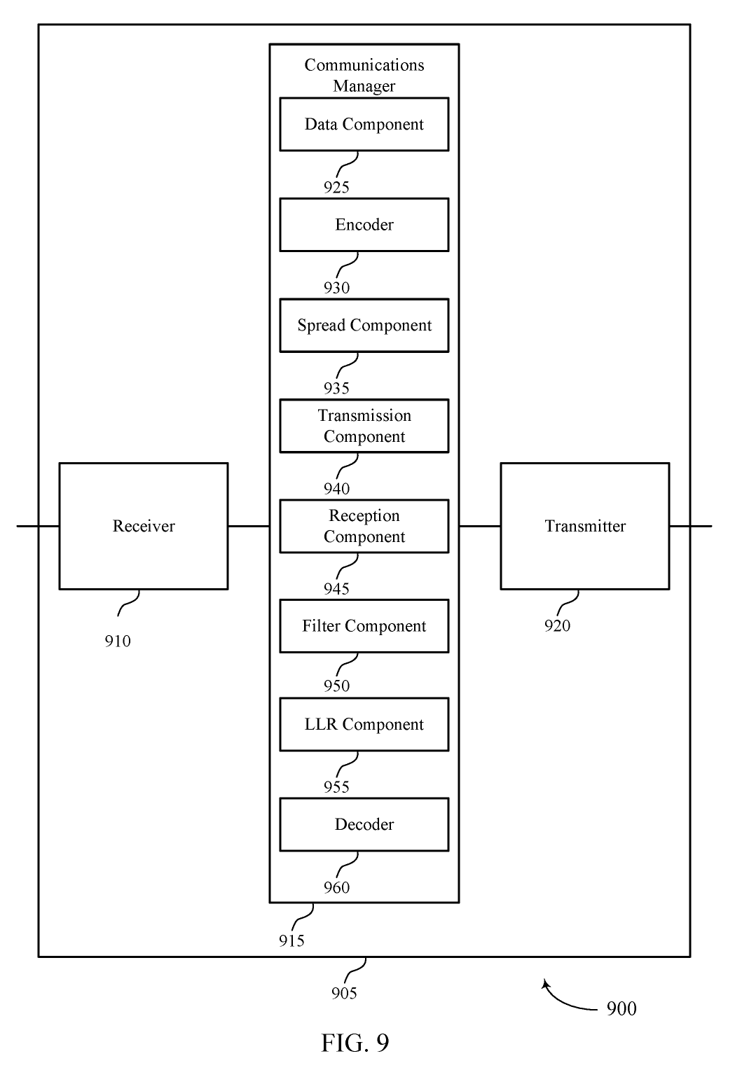

FIG. 9 shows a block diagram 900 of a wireless device 905 that supports multi-layer rate splitting for wireless communications in accordance with aspects of the present disclosure. Wireless device 905 may be an example of aspects of a wireless device 805 or a base station 105 or UE 115 as described with reference to FIG. 8. Wireless device 905 may include receiver 910, communications manager 915, and transmitter 920. Wireless device 905 may also include a processor. Each of these components may be in communication with one another (e.g., via one or more buses).

Receiver 910 may receive information such as packets, user data, or control information associated with various information channels (e.g., control channels, data channels, and information related to multi-layer rate splitting for wireless communications, etc.). Information may be passed on to other components of the device. The receiver 910 may be an example of aspects of the transceiver 1135 described with reference to FIG. 11. The receiver 910 may utilize a single antenna or a set of antennas.

Communications manager 915 may be an example of aspects of the communications manager 1115 described with reference to FIG. 11. Communications manager 915 may also include data component 925, encoder 930, spread component 935, transmission component 940, reception component 945, filter component 950, LLR component 955, and decoder 960.

Data component 925 may identify a data stream for transmission to a wireless device, split the data stream into multiple data sub-streams, synchronize the multiple data sub-streams with respect to each other, and split the data stream into multiple data sub-streams based on the number of multiple data sub-streams.

Encoder 930 may encode each of the multiple data sub-streams according to a code rate based on a number of the multiple data sub-streams and encode the data stream according to a code rate based on a number of multiple data sub-streams. In some cases, the respective average code rates for the multiple data sub-streams are inversely proportional to the number of the multiple data sub-streams. In some cases, the respective average code rates for the multiple data sub-streams are the same for each of the multiple data sub-streams. In some cases, the respective average code rates for the multiple data sub-streams are proportional to a number of information bits in each of the multiple data sub-streams. In some cases, the respective average code rates for the multiple data sub-streams correspond to a ratio of a number of information bits in each of the multiple data sub-streams and a total number of information bits.

Spread component 935 may spread each of the multiple data sub-streams using respective spreading codes and apply a scaling factor to each of the multiple data sub-streams after spreading, where the scaling factor includes one or both of a phase rotation factor or a power scaling factor. In some cases, a number of the respective spread codes is equal to the number of the multiple data sub-streams. In some cases, the respective spread codes are orthogonal to each other. In some cases, the respective spread codes for at least two of the multiple data sub-streams are different.

Transmission component 940 may transmit, to the wireless device, a combined data stream that includes each of the spread multiple data sub-streams according to a code division multiplexed scheme, combine each of the spread multiple data sub-streams to obtain the combined data stream, apply a scrambling code to the combined data stream prior to transmitting the combined data stream, where the scrambling code is specific to the wireless device, and apply a cyclic prefix to the combined data stream prior to transmitting the combined data stream, where the cyclic prefix includes one of a short cyclic prefix or a long cyclic prefix. In some cases, the cyclic prefix is applied after an inverse fast fourier transform of an orthogonal frequency division multiplexing waveform is performed. In some cases, the cyclic prefix is applied after a discrete fourier transform followed by an IFFT, of a discrete fourier transform spread orthogonal frequency division multiplexing waveform is performed.

Reception component 945 may receive a set of code-based signals for multiple wireless devices and identify multiple layers of a first code-based signal of the set of code-based signals, the first code-based signal corresponding to a first wireless device.

Filter component 950 may apply respective filters to each layer of the multiple layers of the first code-based signal. In some cases, the respective filters may be respective matched filters. LLR component 955 may compute a set of LLRs for each layer of the multiple layers based at least in part on one or more sets of LLRs of the multiple layers of the other code-based signals to be used for decoding the first code-based signal.

In some examples, the LLR component 955 may compute a second set of LLRs for each layer of the multiple layers based on the decoded set of multiple layers of the first code-based signal and decode the set of the multiple layers of the first code-based signal based on the second set of LLRs.

Decoder 960 may decode a set of the multiple layers of the first code-based signal based on one or more sets of LLRs of the multiple layers. In some cases, the set of the multiple layers includes all layers of the first code-based signal for the first wireless device.

Transmitter 920 may transmit signals generated by other components of the device. In some examples, the transmitter 920 may be collocated with a receiver 910 in a transceiver module. For example, the transmitter 920 may be an example of aspects of the transceiver 1135 described with reference to FIG. 11. The transmitter 920 may utilize a single antenna or a set of antennas.

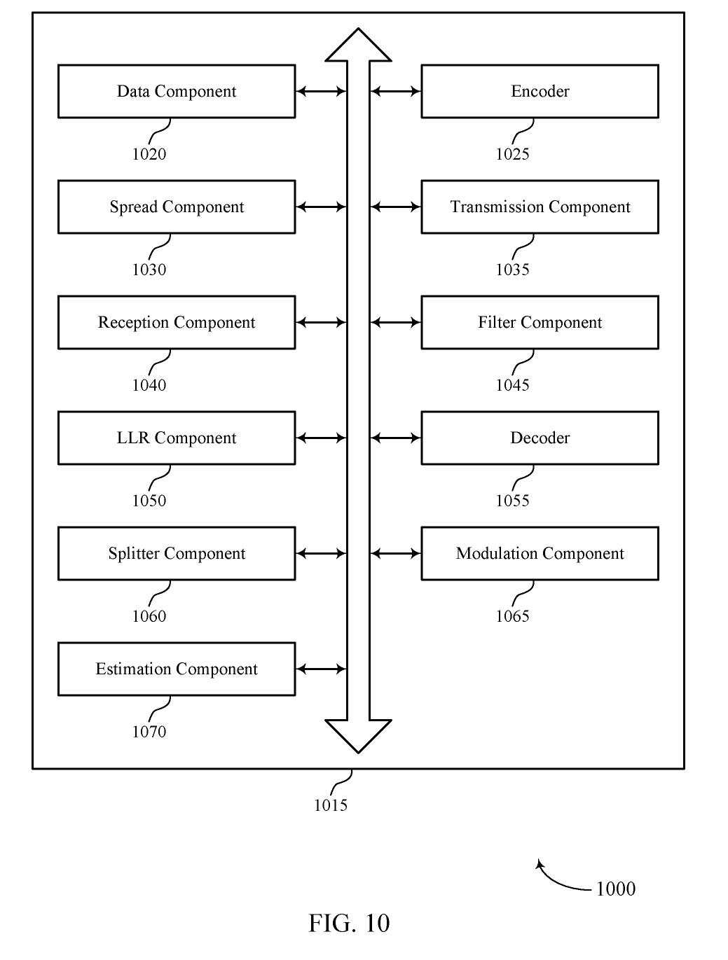

FIG. 10 shows a block diagram 1000 of a communications manager 1015 that supports multi-layer rate splitting for wireless communications in accordance with aspects of the present disclosure. The communications manager 1015 may be an example of aspects of a communications manager 815, a communications manager 915, or a communications manager 1115 described with reference to FIGS. 8, 9, and 11. The communications manager 1015 may include data component 1020, encoder 1025, spread component 1030, transmission component 1035, reception component 1040, filter component 1045, LLR component 1050, decoder 1055, splitter component 1060, modulation component 1065, and estimation component 1070. Each of these modules may communicate, directly or indirectly, with one another (e.g., via one or more buses).

Data component 1020 may identify a data stream for transmission to a wireless device, split the data stream into multiple data sub-streams, synchronize the multiple data sub-streams with respect to each other, and split the data stream into multiple data sub-streams based on the number of multiple data sub-streams.

Encoder 1025 may encode each of the multiple data sub-streams according to a code rate based on a number of the multiple data sub-streams and encode the data stream according to a code rate based on a number of multiple data sub-streams. In some cases, the respective average code rates for the multiple data sub-streams are inversely proportional to the number of the multiple data sub-streams. In some cases, the respective average code rates for the multiple data sub-streams are the same for each of the multiple data sub-streams. In some cases, the respective average code rates for the multiple data sub-streams are proportional to a number of information bits in each of the multiple data sub-streams. In some cases, the respective average code rates for the multiple data sub-streams correspond to a ratio of a number of information bits in each of the multiple data sub-streams and a total number of information bits.

Spread component 1030 may spread each of the multiple data sub-streams using respective spreading codes and apply a scaling factor to each of the multiple data sub-streams after spreading, where the scaling factor includes one or both of a phase rotation factor or a power scaling factor. In some cases, a number of the respective spread codes is equal to the number of the multiple data sub-streams. In some cases, the respective spread codes are orthogonal to each other. In some cases, the respective spread codes for at least two of the multiple data sub-streams are different.

Transmission component 1035 may transmit, to the wireless device, a combined data stream that includes each of the spread multiple data sub-streams according to a code division multiplexed scheme, combine each of the spread multiple data sub-streams to obtain the combined data stream, apply a scrambling code to the combined data stream prior to transmitting the combined data stream, where the scrambling code is specific to the wireless device, and apply a cyclic prefix to the combined data stream prior to transmitting the combined data stream, where the cyclic prefix includes one of a short cyclic prefix or a long cyclic prefix. In some cases, the cyclic prefix is applied after an inverse fast fourier transform of an orthogonal frequency division multiplexing waveform is performed. In some cases, the cyclic prefix is applied after a discrete fourier transform followed by IFFT of a discrete fourier transform spread orthogonal frequency division multiplexing waveform is performed.

Reception component 1040 may receive a set of code-based signals for multiple wireless devices and identify multiple layers of a first code-based signal of the set of code-based signals, the first code-based signal corresponding to a first wireless device. Filter component 1045 may apply respective filters to each layer of the multiple layers of the first code-based signal. In some cases, the respective filters may be respective matched filters. LLR component 1050 may compute a set of LLRs for each layer of the multiple layers based at least in part on one or more sets of LLRs of the multiple layers of the other code-based signals to be used for decoding the first code-based signal.

In some examples, the LLR component 1050 may compute a second set of LLRs for each layer of the multiple layers based on the decoded set of multiple layers of the first code-based signal and decode the set of the multiple layers of the first code-based signal based on the second set of LLRs.

Decoder 1055 may decode a set of the multiple layers of the first code-based signal based on one or more sets of LLRs of the multiple layers. In some cases, the set of the multiple layers includes all layers of the first code-based signal for the first wireless device.

Splitter component 1060 may split the data stream. In some cases, splitting the data stream includes: separating a set of information bits of the data stream into multiple subsets of information bits. In some cases, a number of encoded bits in respective code blocks for each of the multiple data sub-streams are approximately the same across each of the multiple data sub-streams.

Modulation component 1065 may modulate each of the encoded multiple data sub-streams onto respective sets of symbols, where the modulated encoded multiple data sub-streams are spread using respective spreading codes.

Estimation component 1070 may apply a signal estimator to each layer of the multiple layers prior to computing the set of LLRs, where the signal estimator is the same for each of the set of code-based signals.

FIG. 11 shows a diagram of a system 1100 including a device 1105 that supports multi-layer rate splitting for wireless communications in accordance with aspects of the present disclosure. Device 1105 may be an example of or include the components of wireless device 805, wireless device 905, or a base station 105 or UE 115 as described above, e.g., with reference to FIGS. 8 and 9. Device 1105 may include components for bi-directional voice and data communications including components for transmitting and receiving communications, including communications manager 1115, processor 1120, memory 1125, software 1130, transceiver 1135, antenna 1140, and I/O controller 1145. These components may be in electronic communication via one or more buses (e.g., bus 1110).

Processor 1120 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., functions or tasks supporting multi-layer rate splitting for wireless communications).

Memory 1125 may include random access memory (RAM) and read only memory (ROM). The memory 1125 may store computer-readable, computer-executable software 1130 including instructions that, when executed, cause the processor to perform various functions described herein. In some cases, the memory 1125 may contain, among other things, a basic input/output system (BIOS) which may control basic hardware or software operation such as the interaction with peripheral components or devices.

Software 1130 may include code to implement aspects of the present disclosure, including code to support multi-layer rate splitting for wireless communications. Software 1130 may be stored in a non-transitory computer-readable medium such as system memory or other memory. In some cases, the software 1130 may not be directly executable by the processor but may cause a computer (e.g., when compiled and executed) to perform functions described herein.

Transceiver 1135 may communicate bi-directionally, via one or more antennas, wired, or wireless links as described above. For example, the transceiver 1135 may represent a wireless transceiver and may communicate bi-directionally with another wireless transceiver. The transceiver 1135 may also include a modem to modulate the packets and provide the modulated packets to the antennas for transmission, and to demodulate packets received from the antennas.

In some cases, the wireless device may include a single antenna 1140. However, in some cases the device may have more than one antenna 1140, which may be capable of concurrently transmitting or receiving multiple wireless transmissions.

I/O controller 1145 may manage input and output signals for device 1105. I/O controller 1145 may also manage peripherals not integrated into device 1105. In some cases, I/O controller 1145 may represent a physical connection or port to an external peripheral. In some cases, I/O controller 1145 may utilize an operating system such as iOS®, ANDROID®, MS-DOS®, MS-WINDOWS®, OS/2®, UNIX®, LINUX®, or another known operating system. In other cases, I/O controller 1145 may represent or interact with a modem, a keyboard, a mouse, a touchscreen, or a similar device. In some cases, I/O controller 1145 may be implemented as part of a processor. In some cases, a user may interact with device 1105 via I/O controller 1145 or via hardware components controlled by I/O controller 1145.

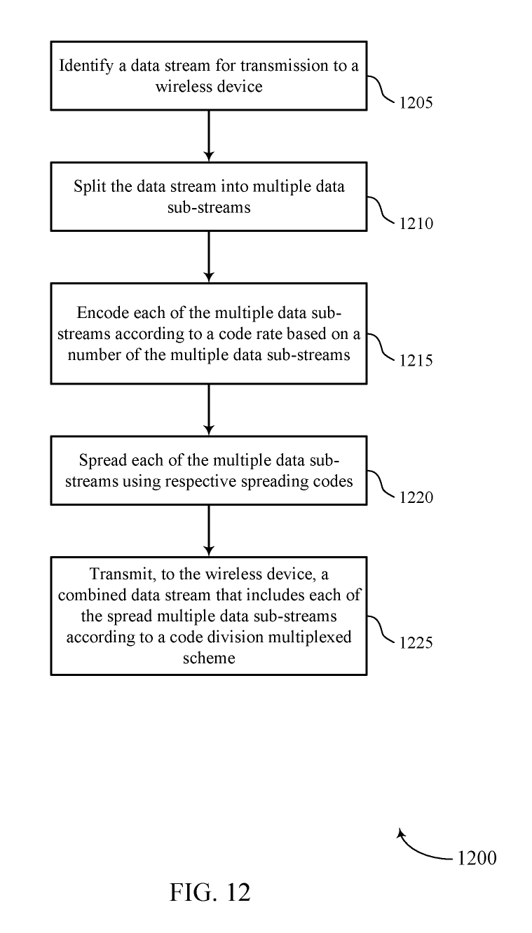

FIG. 12 shows a flowchart illustrating a method 1200 for multi-layer rate splitting for wireless communications in accordance with aspects of the present disclosure. The operations of method 1200 may be implemented by a base station 105 or UE 115 or its components as described herein. For example, the operations of method 1200 may be performed by a communications manager as described with reference to FIGS. 8 through 11. In some examples, a base station 105 or UE 115 may execute a set of codes to control the functional elements of the device to perform the functions described below. Additionally, the base station 105 or UE 115 may perform aspects of the functions described below using special-purpose hardware.

At block 1205 the base station 105 or UE 115 may identify a data stream for transmission to a wireless device. The operations of block 1205 may be performed according to the methods described herein. In certain examples, aspects of the operations of block 1205 may be performed by a data component as described with reference to FIGS. 8 through 11.

At block 1210 the base station 105 or UE 115 may split the data stream into multiple data sub-streams. The operations of block 1210 may be performed according to the methods described herein. In certain examples, aspects of the operations of block 1210 may be performed by a data component as described with reference to FIGS. 8 through 11.

At block 1215 the base station 105 or UE 115 may encode each of the multiple data sub-streams according to a code rate based at least in part on a number of the multiple data sub-streams. The operations of block 1215 may be performed according to the methods described herein. In certain examples, aspects of the operations of block 1215 may be performed by a encoder as described with reference to FIGS. 8 through 11.

At block 1220 the base station 105 or UE 115 may spread each of the multiple data sub-streams using respective spreading codes. The operations of block 1220 may be performed according to the methods described herein. In certain examples, aspects of the operations of block 1220 may be performed by a spread component as described with reference to FIGS. 8 through 11.

At block 1225 the base station 105 or UE 115 may transmit, to the wireless device, a combined data stream that includes each of the spread multiple data sub-streams according to a code division multiplexed scheme. The operations of block 1225 may be performed according to the methods described herein. In certain examples, aspects of the operations of block 1225 may be performed by a transmission component as described with reference to FIGS. 8 through 11.

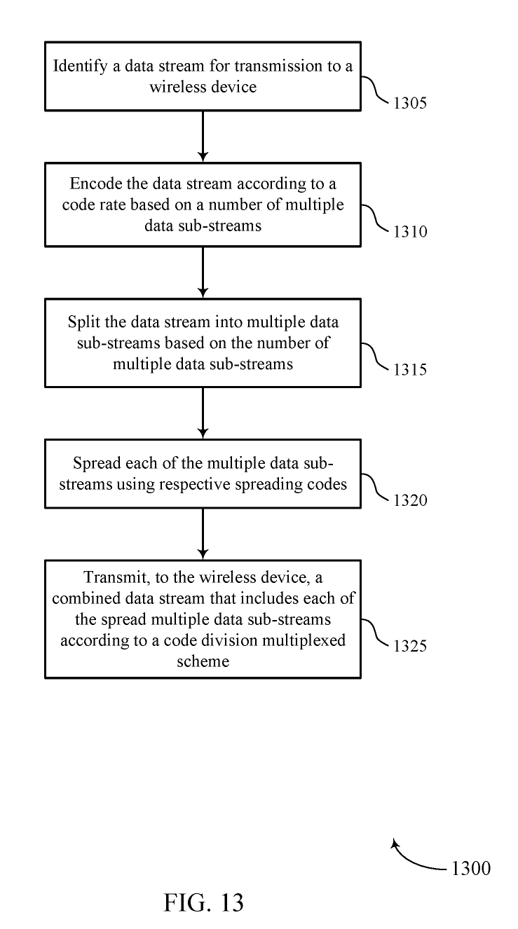

FIG. 13 shows a flowchart illustrating a method 1300 for multi-layer rate splitting for wireless communications in accordance with aspects of the present disclosure. The operations of method 1300 may be implemented by a base station 105 or UE 115 or its components as described herein. For example, the operations of method 1300 may be performed by a communications manager as described with reference to FIGS. 8 through 11. In some examples, a base station 105 or UE 115 may execute a set of codes to control the functional elements of the device to perform the functions described below. Additionally, the base station 105 or UE 115 may perform aspects of the functions described below using special-purpose hardware.

At block 1305 the base station 105 or UE 115 may identify a data stream for transmission to a wireless device. The operations of block 1305 may be performed according to the methods described herein. In certain examples, aspects of the operations of block 1305 may be performed by a data component as described with reference to FIGS. 8 through 11.

At block 1310 the base station 105 or UE 115 may encode the data stream according to a code rate based at least in part on a number of multiple data sub-streams. The operations of block 1310 may be performed according to the methods described herein. In certain examples, aspects of the operations of block 1310 may be performed by a encoder as described with reference to FIGS. 8 through 11.

At block 1315 the base station 105 or UE 115 may split the encoded data stream into multiple encoded data sub-streams based at least in part on the number of multiple data sub-streams. The operations of block 1315 may be performed according to the methods described herein. In certain examples, aspects of the operations of block 1315 may be performed by a data component as described with reference to FIGS. 8 through 11.

At block 1320 the base station 105 or UE 115 may spread each of the multiple encoded data sub-streams using respective spreading codes. The operations of block 1320 may be performed according to the methods described herein. In certain examples, aspects of the operations of block 1320 may be performed by a spread component as described with reference to FIGS. 8 through 11.

At block 1325 the base station 105 or UE 115 may transmit, to the wireless device, a combined data stream that includes each of the encoded spread multiple data sub-streams according to a code division multiplexed scheme. The operations of block 1325 may be performed according to the methods described herein. In certain examples, aspects of the operations of block 1325 may be performed by a transmission component as described with reference to FIGS. 8 through 11.

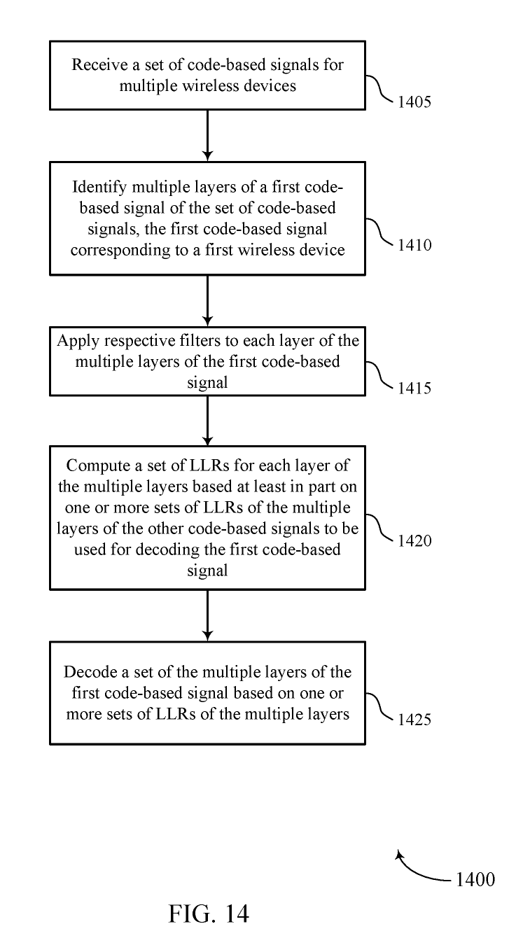

FIG. 14 shows a flowchart illustrating a method 1400 for multi-layer rate splitting for wireless communications in accordance with aspects of the present disclosure. The operations of method 1400 may be implemented by a base station 105 or UE 115 or its components as described herein. For example, the operations of method 1400 may be performed by a communications manager as described with reference to FIGS. 8 through 11. In some examples, a base station 105 or UE 115 may execute a set of codes to control the functional elements of the device to perform the functions described below. Additionally, the base station 105 or UE 115 may perform aspects of the functions described below using special-purpose hardware.

At block 1405 the base station 105 or UE 115 may receive a set of code-based signals for multiple wireless devices. The operations of block 1405 may be performed according to the methods described herein. In certain examples, aspects of the operations of block 1405 may be performed by a reception component as described with reference to FIGS. 8 through 11.

At block 1410 the base station 105 or UE 115 may identify multiple layers of a first code-based signal of the set of code-based signals, the first code-based signal corresponding to a first wireless device. The operations of block 1410 may be performed according to the methods described herein. In certain examples, aspects of the operations of block 1410 may be performed by a reception component as described with reference to FIGS. 8 through 11.

In some cases, at block 1415, the base station 105 or UE 115 may apply respective filters to each layer of the multiple layers of the first code-based signal. In some cases, the respective filters may be respective matched filters. The operations of block 1415 may be performed according to the methods described herein. In certain examples, aspects of the operations of block 1415 may be performed by a filter component as described with reference to FIGS. 8 through 11.

At block 1420 the base station 105 or UE 115 may compute a set of LLRs for each layer of the multiple layers based at least in part on one or more sets of LLRs of the multiple layers of the other code-based signals to be used for decoding the first code-based signal. The operations of block 1420 may be performed according to the methods described herein. In certain examples, aspects of the operations of block 1420 may be performed by a LLR component as described with reference to FIGS. 8 through 11.

At block 1425 the base station 105 or UE 115 may decode a set of the multiple layers of the first code-based signal based at least in part on one or more sets of LLRs of the multiple layers. The operations of block 1425 may be performed according to the methods described herein. In certain examples, aspects of the operations of block 1425 may be performed by a decoder as described with reference to FIGS. 8 through 11.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE and LTE-A are releases of UMTS that use E-UTRA. UTRA, E-UTRA, UMTS, LTE, LTE-A, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE or an NR system may be described for purposes of example, and LTE or NR terminology may be used in much of the description, the techniques described herein are applicable beyond LTE or NR applications.

A macro cell generally covers a relatively large geographic area (e.g., several kilometers in radius) and may allow unrestricted access by UEs 115 with service subscriptions with the network provider. A small cell may be associated with a lower-powered base station 105, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
identifying a data stream for transmission to a wireless device;
splitting the data stream into multiple data sub-streams;
encoding each of the multiple data sub-streams according to a code rate based at least in part on a number of the multiple data sub-streams;
spreading each of the multiple data sub-streams using respective spreading codes; and
transmitting, to the wireless device, a combined data stream that includes each of the spread multiple data sub-streams according to a code division multiplexed scheme.

2. The method of claim 1, further comprising:
modulating each of the encoded multiple data sub-streams onto respective sets of symbols, wherein the modulated encoded multiple data sub-streams are spread using respective spreading codes for the transmission to the wireless device.

3. The method of claim 2, further comprising:
combining each of the spread multiple data sub-streams to obtain the combined data stream.

4. The method of claim 3, further comprising:
applying a scrambling code to the combined data stream prior to transmitting the combined data stream, wherein the scrambling code is specific to the wireless device.

5. The method of claim 1, wherein splitting the data stream comprises:
separating a set of information bits of the data stream into multiple subsets of information bits.

6. The method of claim 5, wherein a number of encoded bits in respective code blocks for each of the multiple data sub-streams are approximately the same across each of the multiple data sub-streams.

7. The method of claim 1, further comprising:
synchronizing the multiple data sub-streams with respect to each other.

8. The method of claim 1, wherein the respective average code rates for the multiple data sub-streams are inversely proportional to the number of the multiple data sub-streams.

9. The method of claim 8, wherein the respective average code rates for the multiple data sub-streams are the same for each of the multiple data sub-streams.

10. The method of claim 8, wherein the respective average code rates for the multiple data sub-streams are proportional to a number of information bits in each of the multiple data sub-streams.

11. The method of claim 8, wherein the respective average code rates for the multiple data sub-streams correspond to a ratio of a number of information bits in each of the multiple data sub-streams and a total number of information bits.

12. The method of claim 1, wherein a number of the respective spread codes is equal to the number of the multiple data sub-streams.

13. The method of claim 12, wherein the respective spread codes are orthogonal to each other.

14. The method of claim 1, wherein the respective spread codes for at least two of the multiple data sub-streams are different.

15. The method of claim 1, further comprising:
applying a scaling factor to each of the multiple data sub-streams after spreading, wherein the scaling factor comprises one or both of a phase rotation factor or a power scaling factor.

16. The method of claim 1, further comprising:
applying a cyclic prefix to the combined data stream prior to transmitting the combined data stream, wherein the cyclic prefix comprises one of a short cyclic prefix or a long cyclic prefix.

17. The method of claim 16, wherein the cyclic prefix is applied after an inverse fast fourier transform of an orthogonal frequency division multiplexing waveform is performed.

18. The method of claim 16, wherein the cyclic prefix is applied after spreading by a discrete fourier transform (DFT) followed by an inverse fast fourier transform on the DFT-spread signal of a DFT-spread orthogonal frequency division multiplexing waveform.

19. A method for wireless communication, comprising:
identifying a data stream for transmission to a wireless device;
encoding the data stream according to a code rate based at least in part on a number of multiple data sub-streams;
splitting the encoded data stream into multiple encoded data sub-streams based at least in part on the number of multiple data sub-streams;
spreading each of the multiple encoded data sub-streams using respective spreading codes; and
transmitting, to the wireless device, a combined data stream that includes each of the encoded spread multiple data sub-streams according to a code division multiplexed scheme.

20. A method for wireless communication, comprising:
receiving a set of code-based signals for multiple wireless devices;
identifying multiple layers of a first code-based signal of the set of code-based signals, the first code-based signal corresponding to a first wireless device;
computing a set of log-likelihood ratios (LLRs) for each layer of the multiple layers based at least in part on one or more sets of LLRs determined from the multiple layers of the other code-based signals of the set of code-based signals to be used for decoding the first code-based signal; and
decoding a set of the multiple layers of the first code-based signal based at least in part on one or more sets of LLRs of the multiple layers.

21. The method of claim 20, further comprising:
applying respective filters to each layer of the multiple layers of the first code-based signal.

22. The method of claim 20, further comprising:
computing a second set of LLRs for each layer of the multiple layers based at least in part on the decoded set of multiple layers of the first code-based signal; and
decoding the set of the multiple layers of the first code-based signal based at least in part on the second set of LLRs.

23. The method of claim 20, further comprising:
applying a signal estimator to each layer of the multiple layers prior to computing the set of LLRs, wherein the signal estimator is the same for each of the set of code-based signals.

24. The method of claim 20, wherein the set of the multiple layers comprises all layers of the first code-based signal for the first wireless device.

25. An apparatus for wireless communication, comprising:
a processor;
memory in electronic communication with the processor; and
instructions stored in the memory and operable, when executed by the processor, to cause the apparatus to:
identify a data stream for transmission to a wireless device;
split the data stream into multiple data sub-streams;
encode each of the multiple data sub-streams according to a code rate based at least in part on a number of the multiple data sub-streams;
spread each of the multiple data sub-streams using respective spreading codes; and
transmit, to the wireless device, a combined data stream that includes each of the spread multiple data sub-streams according to a code division multiplexed scheme.

26. The apparatus of claim 25, wherein the instructions are further executable by the processor to:
modulate each of the encoded multiple data sub-streams onto respective sets of symbols, wherein the modulated encoded multiple data sub-streams are spread using respective spreading codes for the transmission to the wireless device.

27. The apparatus of claim 26, wherein the instructions are further executable by the processor to:
combine each of the spread multiple data sub-streams to obtain the combined data stream.

28. The apparatus of claim 27, wherein the instructions are further executable by the processor to:
apply a scrambling code to the combined data stream prior to transmitting the combined data stream, wherein the scrambling code is specific to the wireless device.

29. The apparatus of claim 25, wherein the instructions are further executable by the processor to:
separate a set of information bits of the data stream into multiple subsets of information bits.

30. The apparatus of claim 29, wherein a number of encoded bits in respective code blocks for each of the multiple data sub-streams are approximately the same across each of the multiple data sub-streams.
